(19) United States
(12) Patent Application Publication
(10) Pub. No.: US 2002/0122112 A1
(43) Pub. Date: Sep. 5, 2002

(54) GROUP-WISE VIDEO CONFERENCING USES 3D-GRAPHICS MODEL OF BROADCAST EVENT

(76) Inventors: RAOUL MALLART, MOUNTAIN VIEW, CA (US); ATUL SINHA, CUPERTINO, CA (US)

Correspondence Address: US PHILIPS CORPORATION, CORPORATE PATENT COUNSEL, 580 WHITE PLAINS RD, TARRYTOWN, NY, 10591

(21) Appl. No.: 09/053,448

(22) Filed: Apr. 10, 1998

(51) Int. Cl. H04N 7/14; H04N 7/173; G06F 3/00; G06F 13/00

(52) U.S. Cl. 348/14.08; 348/14.09; 725/105

(57) ABSTRACT

A TV broadcast service to multiple geographically distributed end users is integrated with a conferencing mode. Upon a certain event in the broadcast, specific groups of end users are switched to a conference mode under software control so that the group is enabled to discuss the event. The conference mode is enhanced by a 3D graphics model of the video representation of the event that is downloaded to the groups. The end users are capable of interacting with the model to discuss alternatives to the event.

### FIELD OF THE INVENTION

The invention relates to a method and a system for enhancing broadcasting with a service that enables interaction among multiple end users that are geographically distributed.

### BACKGROUND ART

Examples of communication involving multiple users are a broadcast and a conference. The broadcast is typically a one-to-many exchange of pre-recorded or real time information without interaction of the receiving party with the broadcasting process. A conference is a form wherein dialogues are typically real-time and dynamic in the sense that receiver and sender interact and frequently change their roles and determine the information exchanged.

Examples of multimedia methods and systems in a multiple-user, interactive virtual environment that enables conferencing are discussed in, for example, U.S. patent applications of Philips Electronics, Ser. Nos. 08/373,737 (PHN 14,719); 08/597,439 (PHN 15,187) and 08/828,468 (PHN 15,769), herewith incorporated by reference. In an implementation of the known systems, a cable-TV network connects multiple users to an application server. The server provides the graphics for a virtual environment via teletext pages, each respective one supplying the graphics data for a respective user. The telephone network is being used for communicating to the server commands from the user controlling his/her telephone keys to control his/her graphics avatar in the virtual environment. The teletext graphics pages get updated under control of the commands entered by the user. The telephone network is also being used to enable communication between users under control of a chat box application run on the server.

### OBJECT OF THE INVENTION

Currently, broadcast and conference modes of communication systems are implemented in an independent manner with separate applications, e.g., a television broadcast of a sports program and a telephone or video conference between sports experts being consulted via an audio or video link during a live broadcast of the sports event, while the conference is being broadcasted.

It is an object of the invention to provide a new interactive environment, and to broaden the scope of TV broadcast services. It is further object to integrate broadcast and conferencing.

### SUMMARY OF THE INVENTION

To this end, the invention provides a method of controlling communication to multiple end users, different users residing at geographically different locations. The method comprises, in a broadcasting mode, broadcasting content information for receipt by the end users, and, in a conferencing mode, enabling interconnecting at least one subset of the end users through a network and enabling interaction between the end users of the subset. The method enables switching between the broadcasting mode and the conference mode.

The method of the invention thus integrates broadcasting, e.g., TV broadcasting, with conferencing, and controls the switching between these modes. The invention enables users to discuss certain events that occur in the broadcasting. Preferably, certain events in the broadcast mode trigger the switching to the conference mode. Preferably, the conference mode is enhanced with 3D-graphics models of the triggering events in order to serve as a basis for discussion in groups that are smaller than the population of the audience attending the broadcast. Software for real-time conversion of video into 3D graphics is commercially available.

### BRIEF DESCRIPTION OF THE DRAWINGS

The invention is explained by way of example and with reference to the accompanying drawings, wherein:

FIG. 1 is a diagram of a known broadcasting system;

FIG. 2 is a diagram of a system in the invention; and

FIGS. 3-5 are diagrams illustrating the method of the invention

Throughout the figures, same reference numerals indicate similar or corresponding features.

### PREFERRED EMBODIMENTS

Known broadcast system

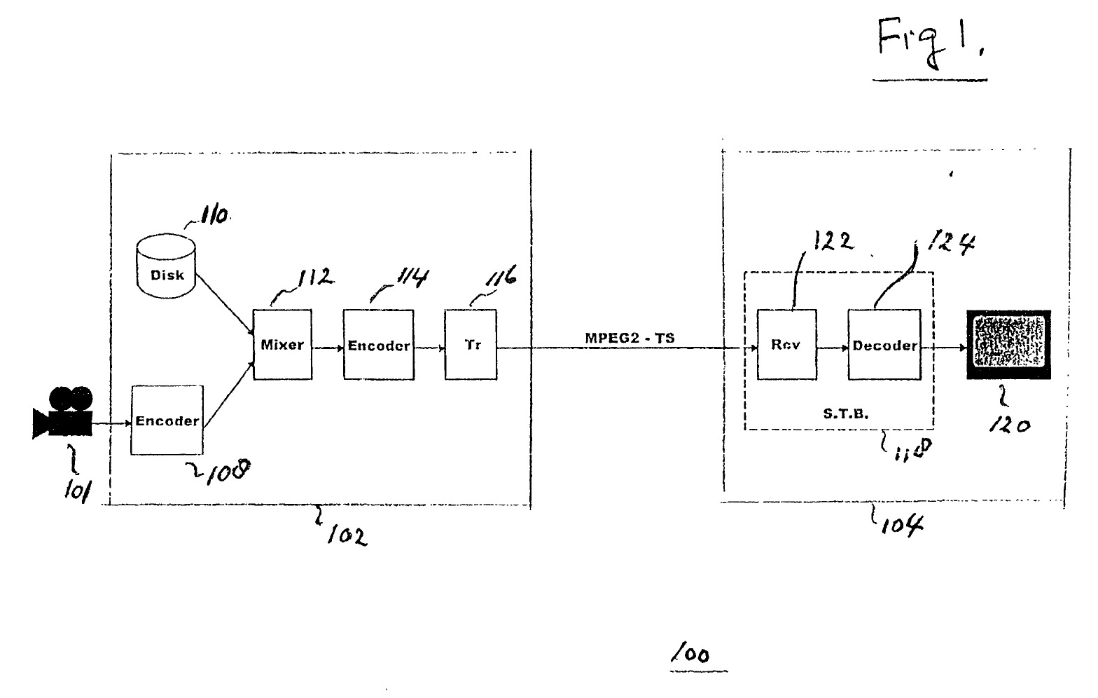

FIG. 1 is a block diagram with the main components of a conventional broadcast system 100 for downloading information to the end users. System 100 has a camera 101, a server 102 and multiple clients, of which only client 104 is shown in order to not obscure the drawing. Server 102 is typically part of professional studio equipment. Client 104 makes accessible to the end user the information broadcasted by server 102. Typically, client 104 comprises consumer electronics equipment.

Server 102 comprises a real-time encoder 108, a storage 110, a mixer 112, a transport encoder 114, and a transmitter 116. Mixer 112 mixes the data supplied by encoder 108 and storage 110. Storage 110 stores pre-recorded video or graphics data. Real-time encoder 108 encodes the video captured by camera 101 into a format suitable for the mixing with the data supplied by storage 110. Encoder 114 encodes the stream into the MPEG-2 TS format. Preferably, the mixing is carried out under control of studio personnel, e.g., the local editor.

Client 104 comprises a set-top box 118 and a television apparatus 120. Set-top box 118 comprises a receiver 122 and a decoder 124. Transmitter 116 in server 102 communicates with receiver 112 of client 104 using an MPEG-2 Transport Stream (TS) format.

Broadcast and conferencing system

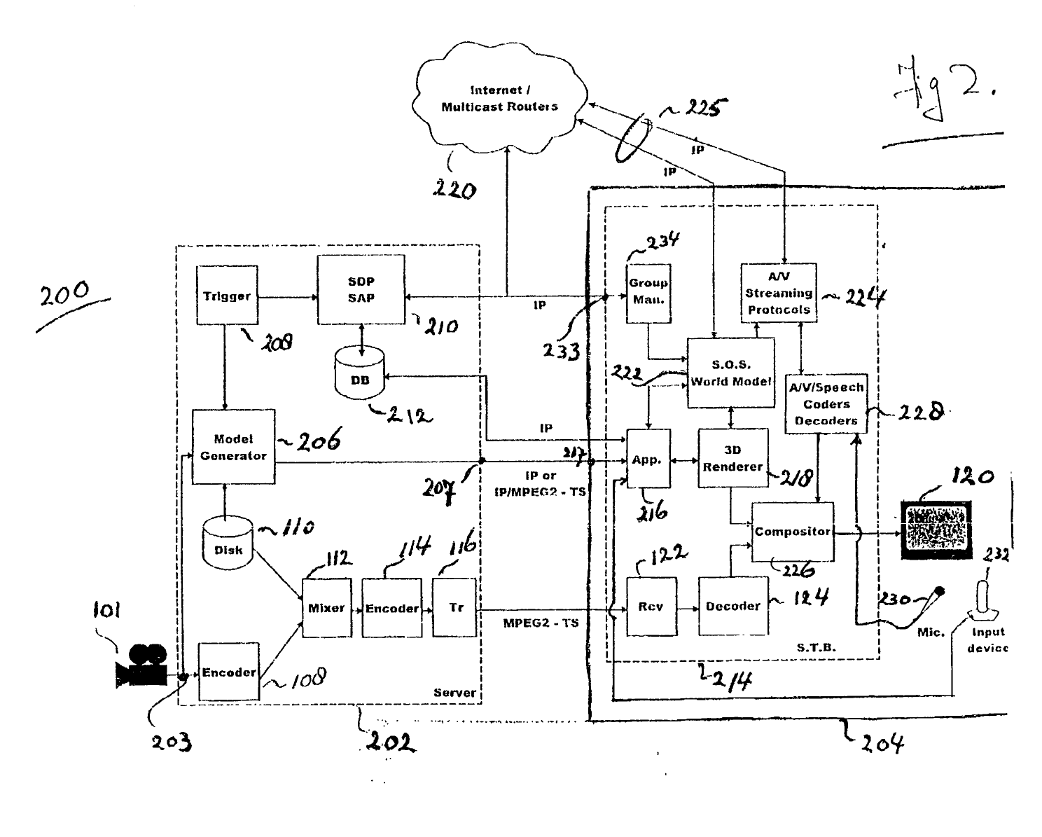

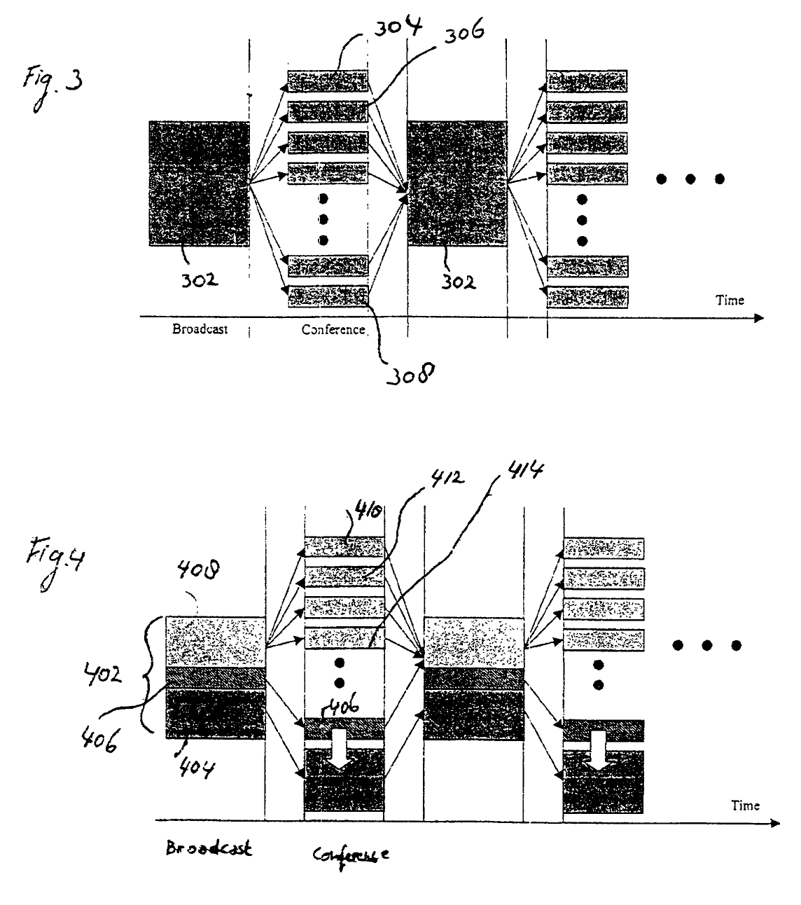

FIG. 2 is a block diagram with the main components of a system 200 of the invention. System 200 integrates broadcasting with conferencing. The system architecture is discussed with reference to FIG. 2, its operation is explained further with reference to FIGS. 3-5.

System 200 presents an integrated approach to broadcast and conferencing modes under software application control. This approach allows switching the users between the broadcast and conference modes. The switching can be controlled by the server, by the end user, or by both. The conference is triggered by the context set by the broadcast mode. In the conference mode, the clients receiving the broadcast are split into smaller groups for multi-user communication, e.g., discussions about a controversial action during a sports event broadcasted. At the end of the conferencing, the users in a group join the broadcast program in a suitable manner. In order to set the context for the conferencing, audio, video and 3D graphics models are generated based on the content of the broadcast programs, and are transported to the users. For the group-wise conferencing, the users' clients employ speech, audio, video, and graphics data, and use streaming protocols, and distributed shared object support.

A service provider can introduce above functionality in an evolutionary manner. This evolution can proceed in a variety of ways. For example, one could introduce this functionality of switching between broadcast and conferencing modes to all users in a stepwise manner, or to a small set of users, e.g., for professional application. The small set of users is then a set of experts who need to establish a multi-user collaboration/communication, e.g., a set of soccer experts who are located at geographically different sites, and who are called in during a broadcast to give their expert opinion on a particular event that occurred to the broadcast soccer match. This collaboration/communication is then broadcasted to all other users. Note that this approach goes beyond current practice of consulting a remotely located expert with an audio or video link.

System 200 comprises a server 202 and multiple clients, of which only a single one, client 204, is shown in order to not obscure the drawing. The clients reside at different locations. In addition to components 101, 108-116, 122 and 124, mentioned above, server 202 comprises other components. Similarly, in addition to receiver 122 and decoder 124, client 204 comprises other components. The additional components manage the broadcast mode and conference mode as explained below.

Server 202 comprises a model generator 206, an event-triggered controller 208, a unit 210 that manages the Session Description Protocols (SDP) and the Session Announcement Protocols (SAP). These protocols are known Internet protocols that support multicasting. For more information, see for example, the paper “How IP Multicast Works, An IP Multicast Initiative White Paper” of authors Vicki Johnson and Marjory Johnson, Stardust Technologies, Inc., as available on the web at: http://www.ipmulticast.com/community/whitepapers/howipmcworks.html, and its literature references. SDP describes multimedia sessions for the purpose of session initiation, such as invitations and announcements. SAP also is meant to ensure authentication and privacy.

Server 202 describes the groups thus formed using the description protocol SDP and informs the clients of the groups being formed by using the announcement protocol SAP. The clients respond by joining a particular group or by waiving to do so. Joining a group automatically activates the conference software application required for enabling the user to participate in the group activities as discussed below. System 200 further comprises a data base 212 with identifications of the clients, such as of client 204, and information regarding the preferences, authorization, etc. of the clients, in order to form the groups for the conferencing mode. This information is based, e.g., upon a query among the users carried out in advance. Model generator 206 is coupled to camera 101 via a server input 203, storage 110 and event-triggered controller 208. Generator 206 generates 3D graphics models, e.g., in a VRML format, of the video data supplied by camera 101, or modifies the 3D graphics models stored in storage 110. Software for real time conversion of video into 3D graphics is known, for example, as a product from Orad Hi-Tech Systems, Ltd. Generator 206 is controlled by controller 208. Controller 208 triggers generator 206 to create a 3D graphics model in response to the occurrence of a certain event. The event corresponds to a pre-programmed condition or is a manual input by, e.g., a sports commentator or studio personnel, during the broadcasting. Controller 208 also triggers the formation of groups of clients, which could be for entering a conference mode, or for watching a conference between the users of other clients. To this end, controller 208 is connected to SDP&SAP unit 210.

Client 204 has a set-top box 214 that comprises a software application 216 for control of a conferencing mode of this particular client 204. Conferencing modes are further explained below and with reference to FIGS. 3-5. Application 216 determines, among other things, the type of interaction and communication between client 204 and the other clients in the group to which it is assigned. To this end, application 216 communicates with data base 212. Client 204 receives via a server output 207 and a client input 217 the 3D graphics data from model generator 206 in server 202, e.g., via the Internet with an Internet Protocol (IP), or via the broadcast channel with IP over MPEG-2 TS. Application 216 determines, based on the authorization and/or preference information in data base 212, whether the user is only permitted to watch the 3D scene from different points of view, or also to modify the scene, e.g., to show alternatives to the broadcast event by changing the scene's configuration that has been modeled. Within this context, generator 206 is preferably capable of generating different models for different groups. Application 216 controls a 3D renderer 218 that comprises, for example, a VRML browser. Decoder 124 and renderer 218 are connected to a compositor 226 that processes the input to prepare for display and play-out to the user at display 120. Compositor 226 is also connected to an output of A/V/Speech coders 228. A/V streaming protocols 226 enable efficient audio/video data transport between the clients via realtime communication channels 225, here through the Internet, in the conferencing mode. A/V/Speech coders 228 take care of the encoding of the A/V/Speech input of client 204 via a microphone 230 and of the decoding of the stream received from the other clients.

Client 204 and the other clients in the same group as client 204 interact via the Internet/Multicast Routers 220. This interaction is supported locally, at client 204, by a world model and distributed shared object support protocols (S.O.S.) 222, in order to maintain overall consistence in the 3D model when being manipulated by authorized users. To this end, a user input device 232, e.g., a joy-stick, is provided at authorized client 204 for modifying or manipulating in another manner the 3D model via application 216. A Group Management unit 234 handles group management, authentication access control and subscription issues such as payment. Unit 234 is, for example, part of application 216 or is a separate application, or is implemented with a smart card reader. Unit 234 receives the relevant control information from server 202 via an input 233.

Note that components 124, 216, 218, 222, 224, 226, 228 and 234 may all be implemented in software.

Operation is as follows. The transition from a broadcast mode to a conference communication mode is triggered by an event. This triggering can be automatic or manual, determined by a sports commentator for a live broadcast or by studio personnel for a pre-recorded program. On the event of a trigger from controller 208, model generator 206 creates the 3D graphics models, possibly different ones for different groups of users.

FIG. 3 illustrates the transitions between a large group 302 watching the broadcast and smaller groups 304, 306, . . . , 308 formed out of larger group.

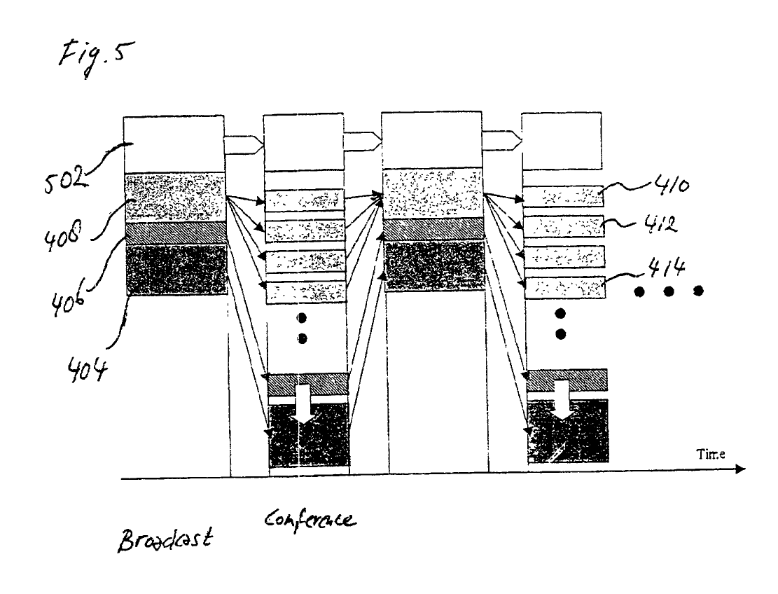

FIG. 4 illustrates a more detailed scenario, wherein a large group 402 comprises a group 404, a group 406 and a group 408. The users in group 404 switch between the broadcast mode reception and the conference mode and remain passive in the sense that they merely receive information and do not interact actively. The users in group 408 are divided among a plurality of smaller groups 410, 412, . . . , 414, each not necessarily of the same users during the session, for participating in the conferencing. The users in group 406 form a panel whose conference is merged with the broadcasting to all users who want to receive this.

FIG. 5 illustrates a refinement on the scenario of FIG. 4. It is possible that not all users can or want to enter the conference mode, either for attending a conference in a small group or for viewing the conference of another group, e.g., of the soccer experts group. For example, not all users capable of receiving the broadcasted information have the equipment supporting the switching between the broadcast mode and the conferencing mode. Under this scenario, a group 502 stays out of and is not hampered by the switching scenario.

We claim:

1. A method of controlling communication to multiple end users at geographically different locations, the method comprising:
in a broadcasting mode broadcasting content information for receipt by the end users;
in a conferencing mode:
enabling interconnecting at least one subset of the end users through a network;
enabling interaction between the end users of the subset via the network; and
enabling switching between the broadcasting mode and the conference mode.

2. The method of claim 1, comprising, while in the conference mode, broadcasting the interaction to another subset of the end-users.

3. The method of claim 1, wherein the switching is enabled by a specific event in the content information broadcasted.

4. The method of claim 1, wherein the content information comprises video information, and wherein the method comprises:
creating a graphics representation of the video information;
in the conference mode supplying the graphics representation to the subset of end users.

5. The method of claim 4, wherein:
one or more specific ones of the end users in the subset is enabled to interactively modify the graphics representation.

6. The method of claim 4, wherein:
while in the conferencing mode, the interaction is broadcasted to another subset of end users; and
one or more specific ones of the end users in the subset is enabled to interactively modify the graphics representation.

7. A system for controlling communication between multiple end users at geographically different locations, the system comprising:
a server;
a respective one of multiple clients for a respective one of the end users, the clients being coupled to the server; wherein:
the server comprises:
a transmission unit for broadcasting content information to the users;
a trigger unit for triggering formation of at least one group of end users upon an event relating to the broadcasting;
a unit for controlling the formation of the group coupled to the trigger unit; and
each respective client being enabled to switch between making accessible to the respective end user the broadcasted content information and enabling entering a conference between the end users of the group via the client.

8. The system of claim 7, wherein:
the server comprises:
a server input for receiving video data; and
a model generator connected to the server input for generating a graphics model based on the video data;
a server output connected to the model generator for supply of the model;
a respective client comprises:
a client input connected to the server output for receipt of the model.

9. A client apparatus for use with a video server, the client apparatus comprising:
a receiver for receiving a TV broadcast;
a coder for coding information received via the Internet from another client; and
an input for receipt of a control signal from the server; wherein:
the apparatus is operative to selectively control switching the apparatus between making accessible to an end user the broadcast or making accessible to the end user a real-time communication channel with another client in response to receipt of the control signal.

10. The apparatus of claim 10, being operative to render a 3D graphics model received from the server and to make the rendered model accessible to the end user while the end user has access to the communication channel.
